(19) United States
(12) Patent Application Publication
(10) Pub. No.: US 2026/0326942 A1
(43) Pub. Date: Oct. 22, 2026

(54) DISPENSER FOR HOLLOW CYLINDRICAL CONTAINERS OPENED AT BOTH ENDS

(71) Applicant: Paulo Roberto jannotti newlands, RIO DE JANEIRO (BR)

(72) Inventor: Paulo Roberto jannotti newlands, RIO DE JANEIRO (BR)

(21) Appl. No.: 19/464,197

(22) Filed: Jan. 29, 2026

(51) Int. Cl. B65B 3/16

(52) U.S. Cl. CPC B65B 3/16

(57) ABSTRACT

Dispenser for hollow cylindrical containers opened at both ends, designed for use with toothpaste and similar pastes, wherein the container is made of environmentally friendly material such as aluminum and configured to replace conventional plastic tubes. The dispenser combines, complements, and improves functions of existing toothpaste dispensers by enabling efficient dispensing from a rigid, fully recyclable cylindrical package, thereby reducing waste and environmental impact while maintaining user convenience.

### 1. FIELD OF THE INVENTION

The present invention relates to a dispenser for hollow cylindrical containers open at both ends, particularly suited for storing and dispensing pasty products. It is designed to build upon and complement the functions and utilities granted to the same inventor under U.S. Pat. No. 12,466,637, issued on Nov. 11, 2025, entitled “Dispensing system for hollow round packages.” The invention also introduces improvements over known dispensing devices that rely on plastic containers preloaded with product and supplied to consumers in packaging that is inadequate for the storage and recycling of pasty goods.

In this context, a complete dispenser, as disclosed herein, results from the combination of two distinct yet mutually complementary components that together form an integrated, environmentally friendly dispenser body for pasty products.

### 2. BACKGROUND

For many years, a wide variety of devices have been proposed to create or improve mechanisms and utilities for dispensing products, including pasty and semi-fluid materials. Numerous solutions can be identified in existing commercial products and patented documents, such as the following:
U.S. Pat. No. 10,888,889, granted by the USPTO on Jan. 12, 2021, to Brugger Gerhardt for “Dispenser for dispensing liquid or pasty substances,” describes a device using rotating displacement pumps, such as rotary piston pumps, rotary vane pumps, gear pumps, and similar units, with operating principles that differ entirely from those of the present invention.
U.S. Pat. No. 4,848,598, granted by the USPTO on Jul. 18, 1989, to Colgate-Palmolive Company for “Dispensing device,” describes a hand-held pump with an internal piston actuated by a rod passing through the piston and driven by an actuator, again without structural or functional similarity to the device claimed herein.
US 2021/0163213, granted by the USPTO to Yan Jian for “Dispensing pump and manufacturing method thereof,” discloses a dispenser in which the product is expelled by an air pump mechanism, with no correspondence to the system of hollow cylindrical containers open at both ends now proposed.
U.S. Pat. No. 3,128,923, granted on Apr. 14, 1964, to Gabler for “Container for receiving and delivering pasty substances,” uses a spring mechanism to expel the contents, differing from the present invention.
U.S. Pat. No. 4,511,068, granted on Apr. 16, 1985, to Bossina for “Dispenser for paste-like products,” also employs a spring-driven expelling system.
U.S. Pat. No. 4,598,843, granted on Jul. 8, 1986, to Foster for “Take-up piston shipping lock for viscous product dispensers,” uses an atmospheric-pressure-operated piston.
U.S. Pat. No. 4,139,127, granted on Feb. 13, 1979, to Gentile for “Plunger-type dispenser with ratchet actuator,” discloses a system that controls the direction of rotation of a rotatable member to expel product.
U.S. Pat. No. 4,979,646, granted on Dec. 25, 1990, to Andris for “Paste dispenser,” relies on bellows to discharge the contents.

Additionally, the USPTO has recently granted to the same applicant of the present application the following patents, which are closely related to the subject matter disclosed herein:
U.S. Pat. No. 11,691,785—“Dispenser with self-deployable telescopic actuator,” issued on Jul. 4, 2023.
U.S. Pat. No. 12,246,906—“Ecologically sustainable dispenser,” issued on Mar. 11, 2025.
U.S. Pat. No. 12,466,637—“Dispensing system for hollow round packages,” issued on Nov. 11, 2025, which is technically associated with and complemented by the present invention.

### 3. SUMMARY OF THE INVENTION

The present invention provides a dispenser for hollow cylindrical containers open at both ends, conceived to combine and complement the functions and utilities granted under U.S. Pat. No. 12,466,637, “Dispensing system for hollow round packages,” to the same inventor. The invention further introduces improvements over dispensing apparatus currently in use, which typically depend on plastic containers preloaded with product and supplied in packaging that is unsuitable from an ecological standpoint for storing pasty products.

The complete dispenser disclosed herein is formed by two individual yet self-complementary parts that together define an integral, environmentally oriented dispenser for pasty goods:
Part 1: A supporting base constituting the structural body of the dispenser, formed by a set of components that define and support the dispensing mechanism, as detailed below.
Part 2: Complementary, fully hollow cylindrical containers, open at both ends and provided with external threads, manufactured from recyclable materials, preferably aluminum alloys, as further described in the detailed description.

Part 1 is intended to be acquired once and retained permanently by the end user for long-term use.

Part 2, represented by the hollow cylindrical containers, is periodically replaced as soon as the contents of a given container are exhausted, after which the empty container is ecologically routed to recycling within a continuous circular cycle.

The invention therefore contemplates the adoption of containers specifically suitable for storing products such as toothpaste, paste soap for bathrooms and kitchen sinks, pasty hair shampoos and conditioners, among others, in materials compatible with environmental protection. A fundamental objective of the invention is to contribute to the improvement of ecosystems by reducing the improper disposal of toxic or non-biodegradable waste, such as conventional plastic toothpaste tubes.

In particular, the containers used for storing pasty products should at least satisfy the following conditions:
Be manufactured from environmentally friendly materials designed to have minimal or no harmful effects on the environment, for example aluminum and its alloys, which can be endlessly recycled within a circular economic strategy.
Be shaped in a geometry that minimizes or essentially eliminates solid residues remaining inside the container after its contents have been dispensed.

Studies and reports indicate that conventional plastic toothpaste tubes are currently supplied in vast quantities and often end up in landfills, with limited or no recycling. Owing to their shape and residual content, these containers are difficult to recover and clean for recycling, which complicates industrial processes and reduces the economic viability of recycling operations.

By contrast, the fully hollow cylindrical containers open at both ends, as disclosed herein, can be selectively collected, including by individual collectors, for delivery to recycling facilities. Because the containers are open at both ends, they can be evacuated and cleaned more easily, so that the walls are substantially free of residual product upon disposal, thereby facilitating washing and processing at the recycling plant and encouraging expansion of this recycling segment.

Another objective of the invention is to provide a new dispensing method comprising a complete set of components, including hollow cylindrical containers and associated parts and mechanisms, to create a dispenser capable of replacing currently used, unsuitable packaging materials with ecologically adequate containers.

A further objective is to offer a device that allows friendly and easy operation, thereby benefiting user groups such as children, elderly persons, and people with disabilities.

Yet another objective is to provide a dispenser for hollow cylindrical containers that allows users to periodically replace emptied containers with new sustainable refills, each fully loaded with a fresh quantity of the selected product.

The aforementioned functions and effects can be implemented, without limitation, through suitable structural and mechanical means, as illustrated in the drawings and described below.

### 4. DESCRIPTION

Toothpaste dispensers fitted with elastic silicone pumps are widely used accessories to which standard plastic toothpaste tubes are attached, offering a cleaner alternative to manual squeezing. These devices employ flexible silicone valves or chambers to draw out a controlled quantity of paste, reducing waste and helping to keep surrounding surfaces clean.

Such dispensers are in common use in households, especially among families and users who prioritize hygiene, since the elastic silicone pump provides hygienic, low-contact dispensing that reduces contamination from fingers or tube rims. They minimize excess paste buildup and are particularly suited to children, who frequently create a mess when using traditional tubes. The use of durable, food-grade silicone materials ensures adequate service life and safety for daily oral-care applications.

Wall-mounted or countertop devices of this type generally incorporate silicone valves for suction-based pumping, activated manually by a mechanical actuator that draws toothpaste from the tube. The pump typically comprises a silicone reservoir with two one-way control valves. When the reservoir is compressed, the buffered toothpaste is expelled through an outlet valve; when the pressure is released, the elasticity of the silicone creates suction that draws toothpaste out of the tube and into the reservoir.

In the dispensers considered in this application, a silicone pump is used as a manual vacuum mechanism. The pump is made of materials having natural elasticity in order to form a system of one-way valves using the following components:
A silicone buffer, formed by a flexible, food-grade silicone chamber that temporarily stores a small quantity of toothpaste.
One-way valves, typically implemented as two silicone valves such as duckbill or check valves, which ensure that toothpaste flows only in one direction, from the tube into the reservoir and then from the reservoir to the user.
An actuator, such as a lever or button, which the user presses with a toothbrush or hand to compress the silicone reservoir.

These components operate together in a pumping cycle comprising the following phases:
1. Compression or squeezing: when the actuator is pressed, the silicone reservoir is compressed, increasing internal pressure and forcing the stored toothpaste through the outlet valve to the toothbrush.
2. Vacuum creation: when pressure on the actuator is released, the silicone returns to its original shape by elastic recovery, thereby creating a vacuum inside the reservoir.
3. Refilling (suction effect): the vacuum draws a fresh dose of toothpaste from the main container through the inlet valve into the reservoir, re-priming the system for the next actuation.

Despite their practical advantages, current toothpaste dispensers are typically supplied to the market with toothpaste stored in polluting plastic tubes, which are unsuitable from an environmental perspective. Consequently, there is an urgent need to replace these plastic tubes with containers made of environmentally compatible raw materials, such as aluminum, as disclosed in the present invention.

### 5. BRIEF DESCRIPTION OF THE DRAWINGS

FIG. 1 is a perspective, exploded view showing the parts used to assemble an elastic silicone pump (1) for a toothpaste dispenser.

FIG. 2A is a perspective view of the bottom region of an elastic silicone pump (1); FIG. 2B is a perspective view of the top region of the same pump.

FIG. 3 illustrates an alternative elastic pump model provided with a cylindrical nozzle at its bottom end.

FIGS. 4A to 4D show, in sequence, the movement of a swinging actuator when operated by the user to extract a portion of toothpaste through the dispenser.

FIGS. 5A to 5D show a case for housing the elastic pump, as well as sequential movements for extracting contents from a toothpaste plastic tube.

FIG. 6A is a front view of an aluminum hollow cylindrical container open at both ends with its nozzle facing upward and ready to receive a cap; FIG. 6B shows the same container inverted, with the cap threaded on the nozzle and the container ready to be filled.

FIGS. 7A to 7D illustrate the system for filling and closing the aluminum hollow cylindrical container open at both ends from its bottom side.

FIGS. 8A and 8B depict attachment of a filled aluminum hollow cylindrical container open at both ends to the threaded socket of an elastic pump.

FIGS. 9A to 9C illustrate the filling system for a hollow cylindrical container opened at both ends and fitted with an enlarged nozzle.

FIGS. 10A to 10C illustrate attachment of an aluminum hollow cylindrical container having an enlarged threaded end to a correspondingly enlarged socket of the elastic pump.

FIGS. 11A to 11C illustrate attachment of an aluminum hollow cylindrical container having a threaded end to the top section of an elastic pump using an intermediate adapter.

### 6. DETAILED DESCRIPTION OF THE DRAWINGS

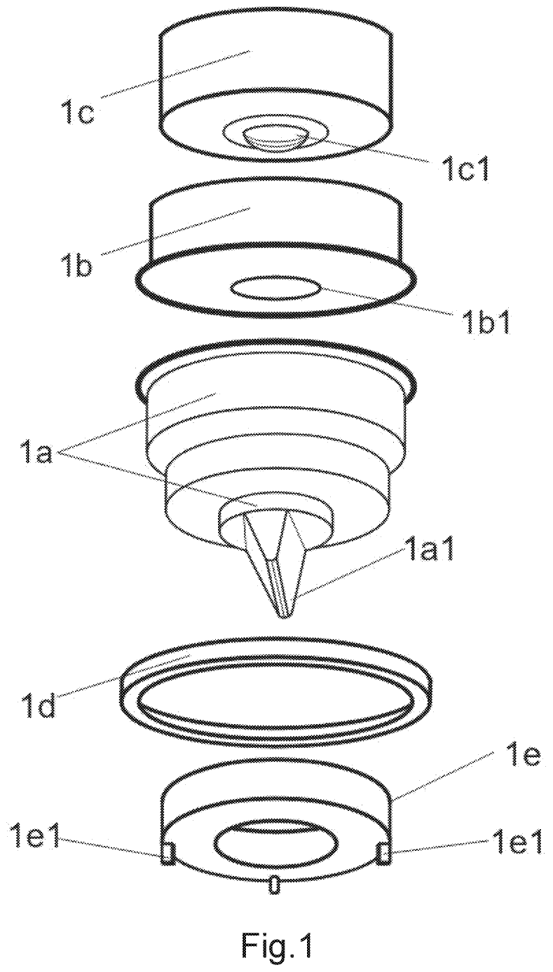

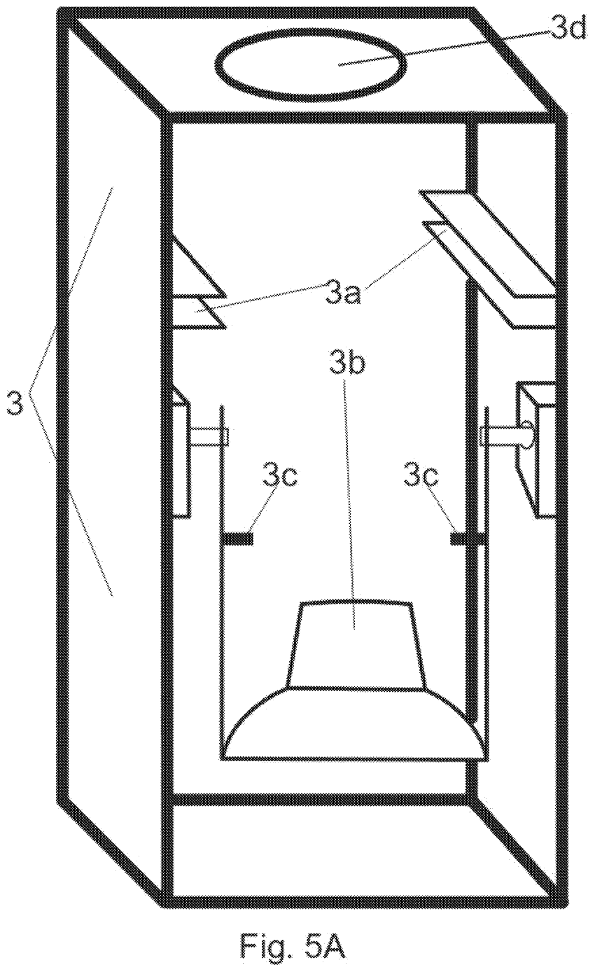

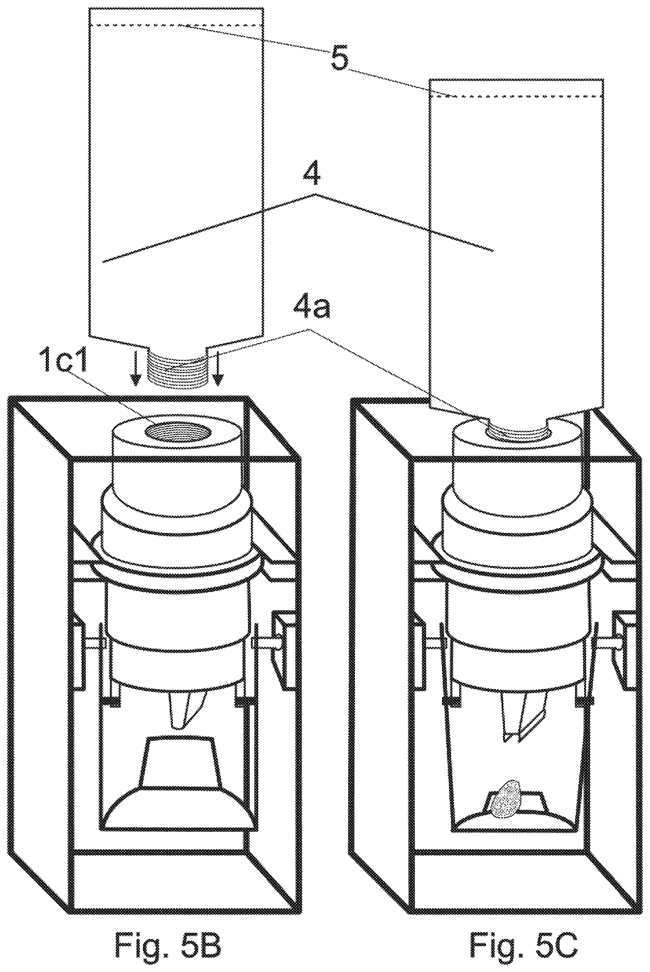

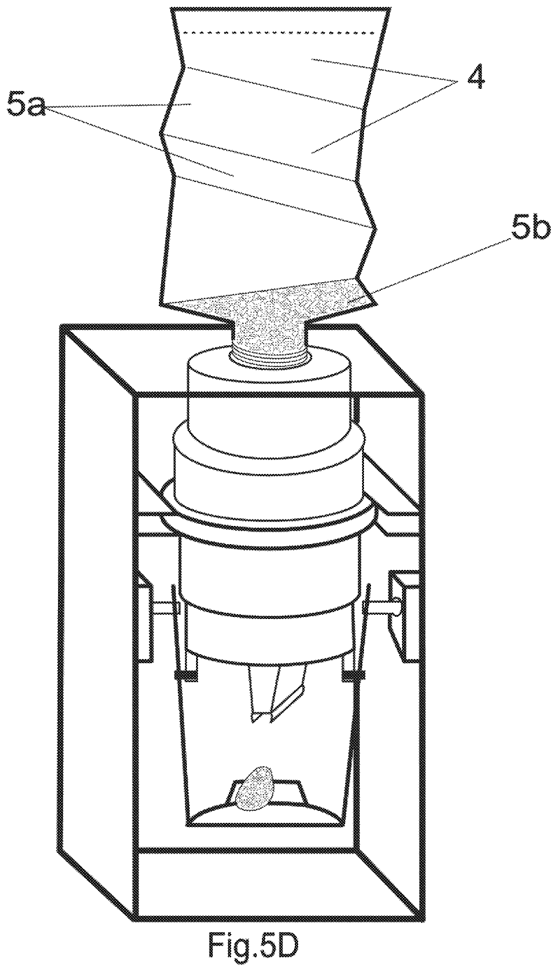

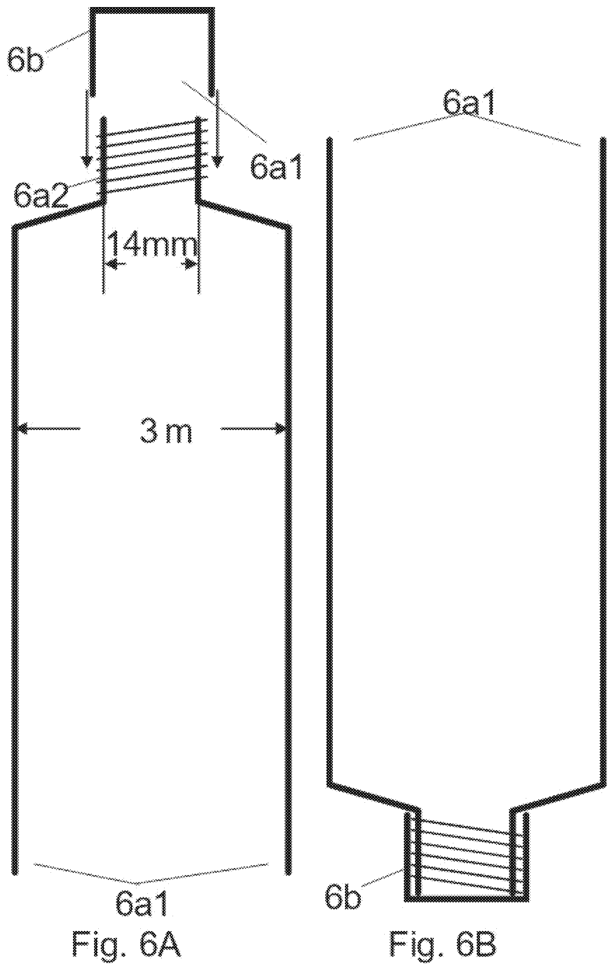

The drawings are organized into three functional groups for clarity:
1. The elastic silicone pump (FIGS. 1 to 4D).
2. The housing case for the elastic silicone pump (FIGS. 5A to 5D).
3. The various configurations and uses of hollow cylindrical containers open at both ends (FIGS. 6A to 11C).

Taken together, the toothpaste dispenser and the “dispensing system for hollow round packages” of U.S. Pat. No. 12,466,637 form a single integrated device that enables the replacement of conventional plastic toothpaste tubes with the hollow cylindrical containers open at both ends disclosed herein.

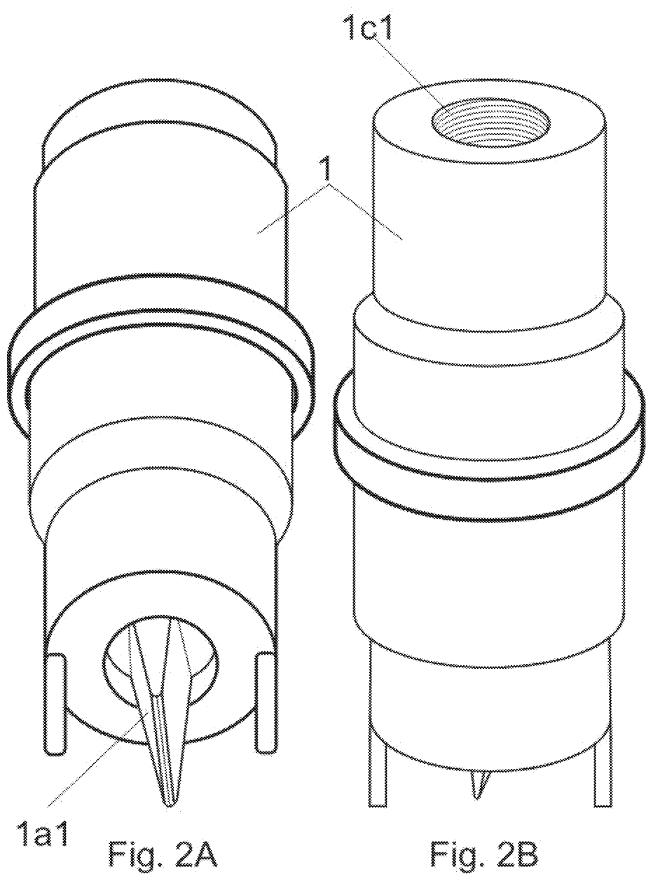

FIG. 1 shows, in exploded view, the individual parts that, when assembled, form the elastic silicone pump (1) illustrated in FIGS. 2A and 2B. In typical dispensers, the pressure pump is formed by five parts, three of which are rigid, high-grade plastic (1b, 1d, 1e) and two of which are made of elastic silicone (1a, 1c).
Element 1c is a silicone tube section having at its top a threaded socket (not shown in this figure) for attachment of the threaded nozzle of the toothpaste container; at its bottom it includes an expansive membrane divided into two halves (1c1) through which toothpaste flows downward when dispensing is requested.
Element 1b is a rigid plastic socket into which the silicone tube 1c is inserted, to provide a conduit for a requested portion of toothpaste towards the silicone chamber 1a and then to the user's toothbrush through valve 1a1.
Element 1a is a flexible silicone chamber that, when compressed by the moving ring 1e (see FIGS. 5A-5D), draws a portion of toothpaste from the tube and releases it through the dispensing valve 1a1.
Element 1d is a junction ring that firmly connects chamber 1a to rigid socket 1b.
Element 1e is a movable steering-wheel-type actuator fixed around the chamber 1a and provided with two symmetric levers 1e1, which receive a force from the case mechanism (described below) and transfer this force to chamber 1a to generate suction and discharge.

FIGS. 2A and 2B are perspective views, from different angles, of a typical elastic silicone pump (1). In FIG. 2A, the dispensing nozzle 1a1 is visible at one end, and in FIG. 2B the threaded socket 1c1 is visible at the opposite end for attachment of a toothpaste container.

FIG. 3 illustrates an alternative elastic pump (2) in which a cylindrical nozzle 2a is incorporated at the bottom end to allow a mechanical closing system that prevents drying, leakage, or contamination of the toothpaste remaining in the dispensing system.

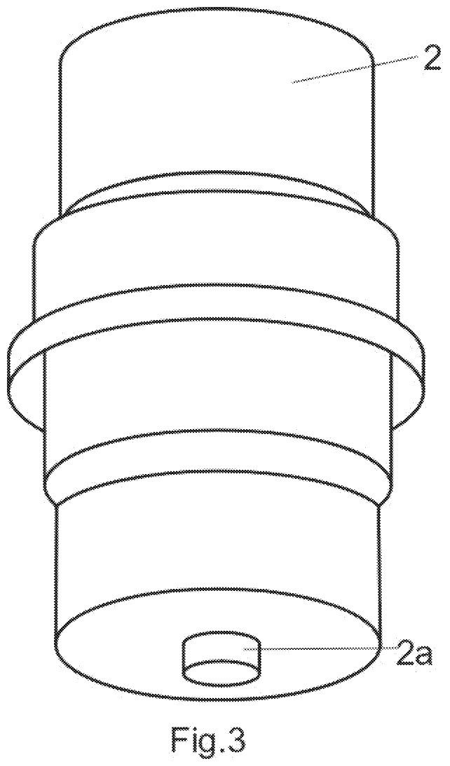

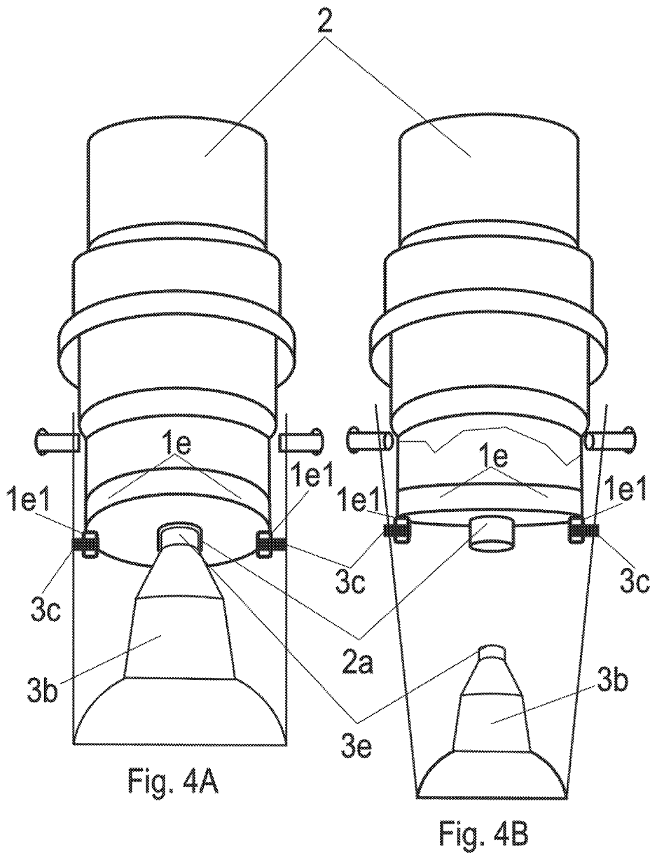

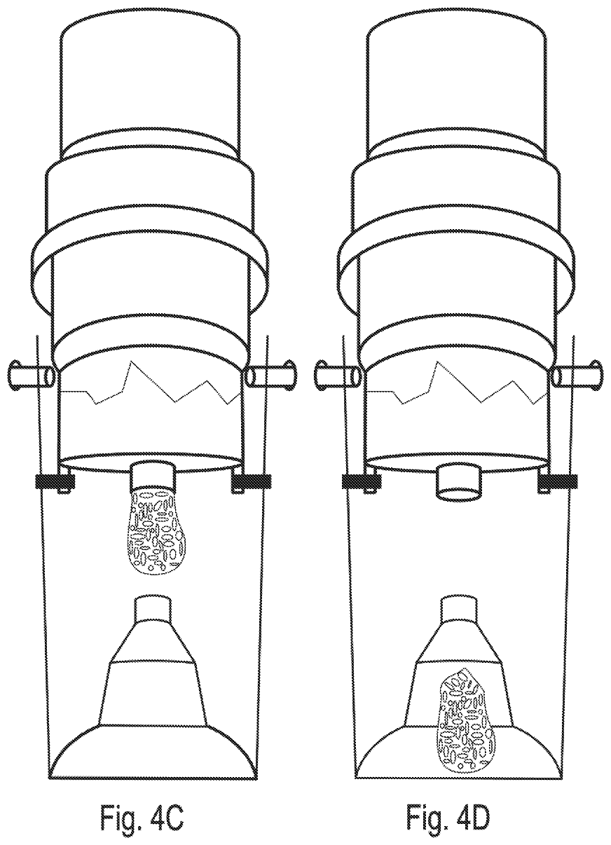

FIGS. 4A to 4D show a mechanical arrangement in which a swinging member 3b, equipped with two lateral elements 3c, cooperates with levers 1e1 to compress and then release chamber 1a while moving a cap 1c relative to nozzle 2a, thereby opening and closing the outlet according to the user's actuation.

FIG. 5A shows a housing case 3 for the elastic pump, with two lateral shelves 3a for holding the pump via ring 1d. The movable swing set 3b, bearing lateral elements 3c, engages levers 1e1 of actuator 1e to compress chamber 1a and produce suction and discharge as previously described. FIGS. 5B and 5C show how the threaded nozzle 4a of a conventional plastic toothpaste tube 4, sealed at its bottom by a hot-sealed line 5, is attached to fitting 1c1 at the top of the elastic pump. FIG. 5D illustrates how such tubes deform after most of their contents have been dispensed, leaving undesirable residual toothpaste 5b inside, which complicates recycling operations. From this point onward (FIGS. 6A-11C), the drawings disclose the ecological solution proposed to replace plastic packaging with aluminum hollow cylindrical containers opened at both ends.

FIG. 6A shows, upright, a hollow cylindrical container 6a1 open at both ends, with a standard body diameter of about 35 mm and a nozzle diameter of about 14 mm, over which a cap 6b is pre-positioned. In FIG. 6B, the same container is inverted, with cap 6b already threaded on the nozzle, so that the larger open end is exposed for filling with toothpaste or other pasty product.

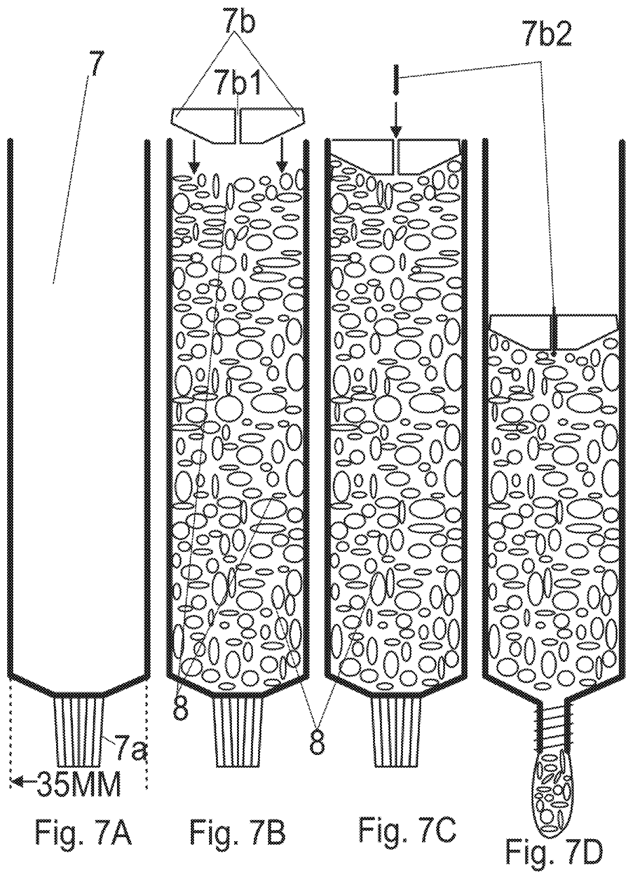

FIGS. 7A to 7D depict a filling and sealing method for a standard 35 mm aluminum tube. In FIG. 7A, the empty container 7, inverted and already capped at its nozzle by cap 7a, is ready to receive a full charge of toothpaste 8 through its open end. After filling to a predetermined level, a movable cylindrical closer 7b provided with a central hole 7b1 is inserted (FIG. 7B). The hole 7b1 allows air trapped above the paste to escape as closer 7b moves downward until it contacts the paste surface, as shown in FIG. 7C.

A sealing pin 7b2, threaded or not, is then used to hermetically close the central hole 7b1 once the desired position is reached. During dispensing, closer 7b moves downward progressively as portions of toothpaste 8 are extracted, maintaining a substantially constant cross section and leaving minimal residue on the container walls, as illustrated in FIG. 7D.

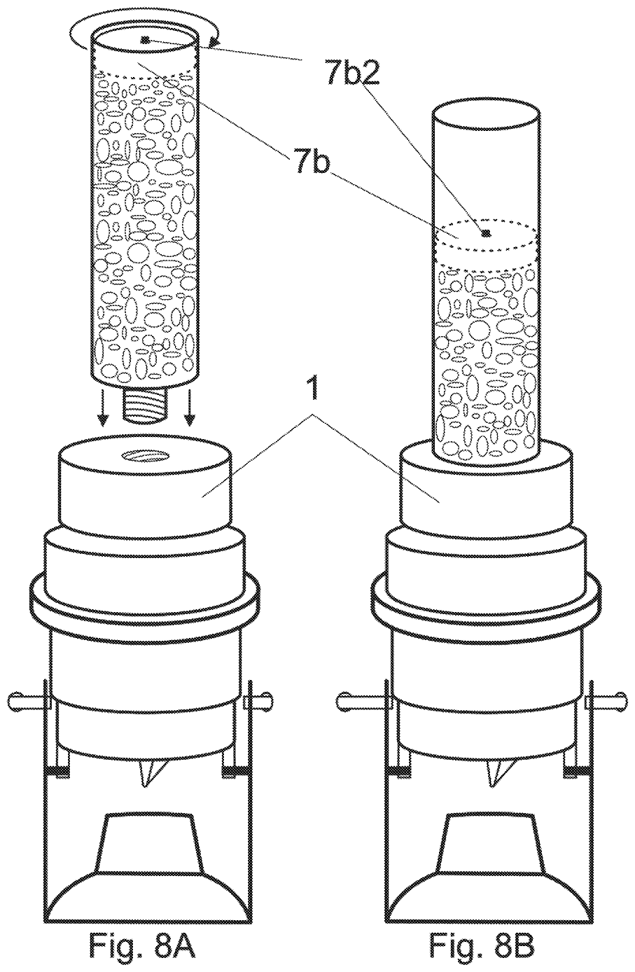

FIGS. 8A and 8B show the attachment of a fully loaded hollow cylindrical container, prepared as in FIGS. 7A-7D and sealed by pin 7b2, to a conventional elastic silicone pump 1. FIG. 8B shows that, as toothpaste is dispensed, the level of product inside the container decreases and closer 7b moves downward correspondingly, without causing structural deformation of the aluminum container.

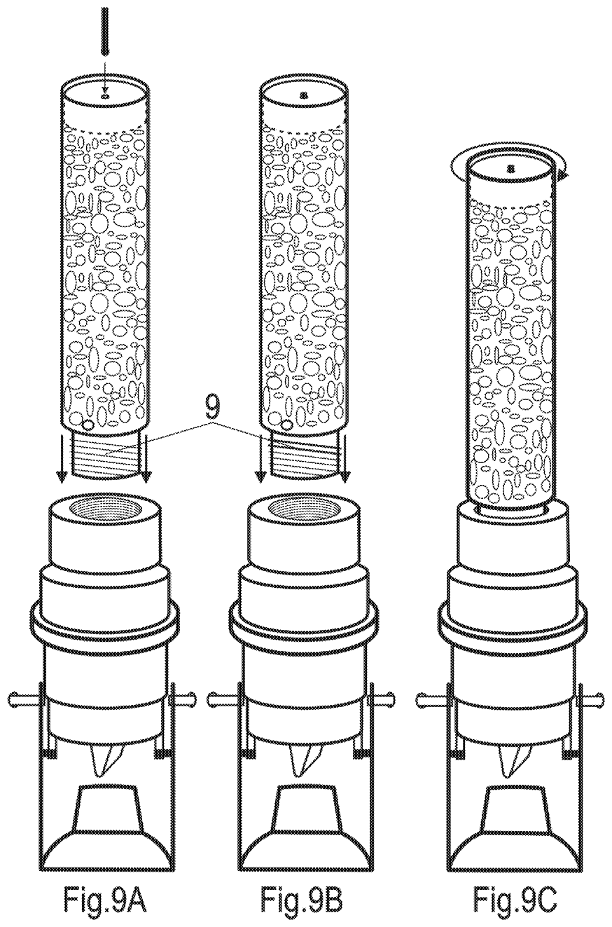

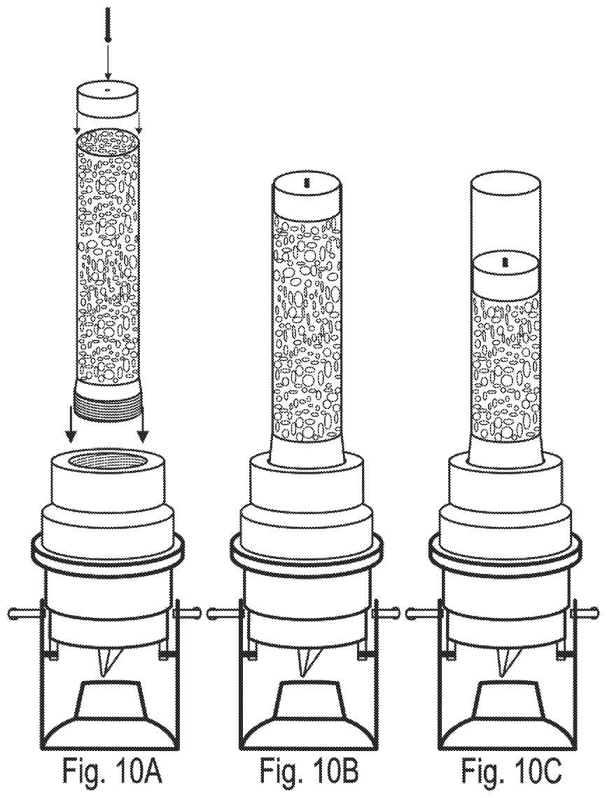

FIGS. 9A to 9C present an aluminum hollow cylindrical container 9 open at both ends and fitted with an enlarged threaded nozzle of about 28 mm in diameter. This configuration is intended to facilitate cleaning and recycling by allowing easier access to the interior for washing tools. FIGS. 10A to 10C show another container variant in which the threaded end has a diameter slightly larger than that of the body, again to improve cleanability and recyclability. To be compatible with this enlarged threaded end, the inlet threaded fitting of the elastic silicone pump must likewise be enlarged, as conceptually illustrated in FIG. 10A and further detailed in FIGS. 10B and 10C.

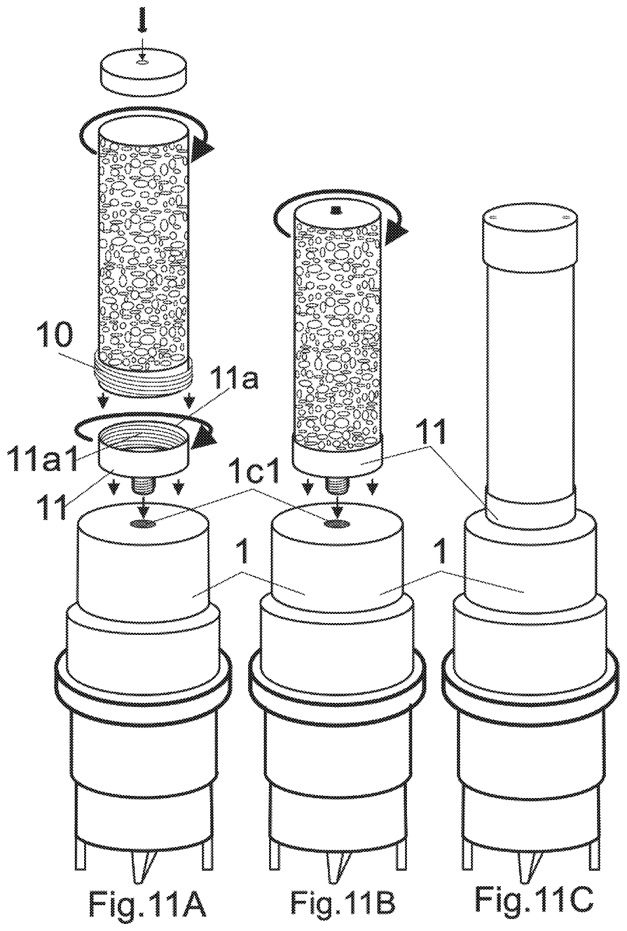

FIGS. 11A to 11C illustrate an indirect fastening method for connecting an enlarged threaded portion 10 of the container to a regular threaded socket 1c1 of the elastic pump 1 using an intermediate threaded connector 11.

The upper half 11a of connector 11 forms a circular connection with an internal thread 11a1 into which the enlarged threaded portion 10 of the container is screwed.

After this connection is established, the assembly comprising the container and connector 11 is threaded into socket 1c1 on top of pump 1, making the system ready for use (FIG. 11C).

A cap 12, provided with small holes, can be added to relieve any vacuum that might form in the upper region of the container during operation.

The invention claimed is:

1. A dispenser system for dispensing a pasty product contained in a hollow cylindrical container that is open at both ends, the system comprising at least one fully hollow cylindrical container having opposed open ends and being formed from recyclable materials comprising aluminum, the cylindrical container being threadably engageable with the support base so that, when the cylindrical container is received and supported by the support base, the dispenser mechanism dispenses the pasty product through one of said open ends, as well as comprising a support base configured to receive and support of at least one said hollow cylindrical container, the support base also comprising a dispenser mechanism of a type used in toothpaste dispensers and being structurally adapted to operatively engage hollow cylindrical containers of any nozzle dimension, to dispense the pasty product therefrom.

2. The dispenser system of claim 1, wherein the hollow cylindrical container is configured to be removed from the support base when depleted, and replaced on the support base by a new, filled hollow cylindrical container, and wherein the depleted hollow cylindrical container is adapted to be sent for recycling in substantially clean condition, thereby providing a reusable, sustainable dispensing cycle with reduced plastic usage in pasty product packaging.

3. The dispenser system as in claim 1, wherein an alternative elastic pump includes a cylindrical discharge nozzle at a bottom end of the pump, as well as a compatible mechanical closing mechanism having two lateral fixed elements configured to engage and advance two symmetrical levers so as to maintain the cylindrical discharge nozzle in a closed position when the dispenser system is in an idle state.

4. The dispenser system for dispensing a pasty product contained in a hollow cylindrical container, as in claim 1, wherein said hollow cylindrical containers are shaped in a favorable geometric format that prevents the presence of solid residues inside it upon the exhaustion of its original contents.

5. A method for loading, closing, and using a hollow cylindrical container open at both ends, comprises the steps of:
setting an empty container upside down with a closing cap already attached to its threaded nozzle;
settle its open end positioned right below a tube filler through which the pasty product is poured into the container;
fill in the hollow cylindrical container open at both ends with the selected product through its open end facing upwards;
closing the open end with a movable cylindrical closer;
Seal the central hole of the movable cylindrical closer with a sealing pin;

6. The method for loading, closing and using a hollow cylindrical container, as in claim 5, wherein the movable cylindrical closer will be displaced downwards in the same pace as portions of the stored toothpaste flows throughout the dispensing nozzle.

7. The method for loading, closing, and using a hollow cylindrical container, as in claim 5, wherein hollow cylindrical containers fitted with enlarged diameters will require a proportional enlargement at the inlet screwed fitting of the elastic pumps for a smooth engagement.

8. The method for loading, closing, and using a hollow cylindrical container, as in claim 5, wherein said hollow cylindrical container has been produced with an enlarged diameter at its open threaded end, whilst the inlet screwed fitting positioned on top of the elastic pump is the same one currently existing in the available toothpaste dispensers, comprising an indirect fastening method through the assistance of an intermediate threaded connector which comprises, in its upper half, a circular connection with internal thread in which the enlarged threaded portion of the hollow circular container is firstly screwed, and thence the set so formed is screwed into the inlet socket of regular diameter existing on top of said elastic silicone pump, by means of an external threaded terminal located at the lower part of the intermediate threaded connector whose diameter is fully compatible with the diameter of the previously referred inlet socket.

9. The method for loading, closing, and using a hollow cylindrical container, as in claim 5, wherein a cap fitted with small holes on its top part has been added, intended to relieve any vacuum therein existing.
